(19) United States
(12) Patent Application Publication
(10) Pub. No.: US 2003/0011270 A1
(43) Pub. Date: Jan. 16, 2003

(54) Motor with core and motor core

(76) Inventor: Hiromitsu Takei, Suwa-gun (JP)

Correspondence Address: HOGAN & HARTSON L.L.P., 500 S. GRAND AVENUE, SUITE 1900, LOS ANGELES, CA, 90071-2611, US

(21) Appl. No.: 10/178,065

(22) Filed: Jun. 19, 2002

(30) Foreign Application Priority Data
Jun. 28, 2001 (JP) 2001-197348

(51) Int. Cl. H02K 1/00

(52) U.S. Cl. 310/216

(57) ABSTRACT

A motor with core has a core having a plurality of salient poles, each of the salient poles having a teeth section defining a magnetic flux converging surface having a width L1 in a circumferential direction and a base section opposing to the magnetic flux converging surface, and a core rib section connecting to the teeth section at the base section of the teeth section, the core rib section having a width L2 in a direction orthogonal to a direction in which the core rib section extends radially. The base section is set at a location that is about (L1−L2)/2 or greater away in the radial direction from the magnetic flux converging surface of the teeth section.

### BACKGROUND OF THE INVENTION

1. Field of the Invention

The present invention relates to motors with core, where each motor is equipped with a core having a plurality of salient poles with a wire wound around each, and also to a core for such motors.

2. Description of Related Art

Motors with core that are generally and widely used have cores made of electromagnetic steel plate laminates. For example, a motor with core shown in FIGS. 9 and 10 is an example of a motor with brush having a structure with four magnetic poles and six core poles (i.e., a 4-6 structure), and this motor with brush has a rotor core 1 shown in FIG. 11 fixed to a rotor shaft 2. The rotor core 1 has six salient poles 3 arranged in the circumferential direction; and an extended section in the radial direction of each of the salient poles 3 constitutes a core rib section 3a, around which is wound a coil wire 3b, while at the end part (the outer end part) in the radial direction of each of the core rib sections 3a is a teeth section 3c that extends in the circumferential direction and has a generally arc shape. And on the outer part in the radial direction of each of the teeth sections 3c is a ring-shaped stator magnet 4, which is placed to circumferentially surround the teeth sections 3c.

An inner rotor-type motor with core shown in FIG. 12 is equipped with a stator core 5. The stator core 5 has core rib sections 5a extending in the radial direction towards the center, and each of the core rib sections 5a has a coil winding 5b wound around it, while at the end part (the inner end part) in the radial direction of each of the core rib sections 5a is a teeth section 5c that extends in a generally arc shape. And a rotor magnet 6 is provided at the center on the inner side in the radial direction of the teeth sections 5c, and the rotor magnet 6 is fixed to a rotor shaft 7.

In such motors with core, the shape and size of each of the teeth sections 3c and 5c of the corresponding core 3 and 5, respectively, are generally determined by the size of the motor and/or the number of magnetic poles on the rotor. Consequently, the respective sizes of the teeth sections 3c and 5c can be larger than the respective magnetic saturation amounts of the corresponding core rib sections 3a and 5a, respectively, in the magnetic circuit; when this happens, the rotation performances can be lowered by cogging, torque ripple, and back electromotive voltage distortion. It is difficult to improve the rotation performances above a certain level due to cogging or the like particularly in motors with few core poles, and this is due to the fact that the shape of the teeth sections becomes elongated in the circumferential direction.

### SUMMARY OF THE INVENTION

In view of the above, the present invention provides a motor with core that can reduce such performance characteristic as cogging and improve the rotation performance through a simple structure.

In accordance with an embodiment of the present invention, a motor with core comprises a core having a plurality of salient poles, each of the salient poles having a teeth section defining a magnetic flux converging surface having a width L1 in a circumferential direction and a base section opposing to the magnetic flux converging surface, and a core rib section connecting to the teeth section at the base section of the teeth section, the core rib section having a width L2 in a direction orthogonal to a direction in which the core rib section extends radially, wherein the base section is set at a location that is about (L1−L2)/2 or greater away in the radial direction from the magnetic flux converging surface of the teeth section.

In other words, in the motor with core having such a structure, the dimension of each magnetic flux inflow/outflow surface of each of the teeth sections up to a section where the teeth section meets the corresponding core rib section, i.e., the dimension from the magnetic flux converging surface of the teeth section to the base section where the teeth section meets the core rib section, is equivalent to or greater than the width of one half side of the magnetic flux converging surface. As a result of this, there would hardly be any magnetic saturation on the magnetic flux inflow/outflow surface at the base section where the teeth section meets the core rib section, which consequently reduces such performance characteristics as cogging, torque ripple and back electromotive voltage distortion.

Furthermore, a motor with core in accordance with another embodiment of the present invention comprises a core having a plurality of salient poles, each of the salient poles having a teeth section defining a magnetic flux converging surface having dummy slots for cogging torque adjustment and having a width L1 in a circumferential direction and a base merging section opposing to the magnetic flux converging surface, and a core rib section connecting to the teeth section at the base merging section of the teeth section, the core rib section having a width L2 in a direction orthogonal to a direction in which the core rib section extends radially, wherein the base merging section is set at a location that is about (L1−L2)/4 or greater away in the radial direction from the magnetic flux converging surface of the teeth section.

In other words, in the motor with core having such a structure, the dimension of each magnetic flux inflow/outflow surface of each of the teeth sections up to a point where the teeth section meets the corresponding core rib section, i.e., the dimension from the magnetic flux converging surface of the teeth section to the base merging section where the teeth section meets the corresponding core rib section, is sufficiently large to the extent that the dummy slots are effective to perform their intended function. As a result of this, magnetic saturation on the magnetic flux inflow/outflow surface at the base merging section where the teeth section meets the core rib section is restricted to the extent that it does not impede the effect of the dummy slots, so that the target rotation performance can be easily obtained.

In either of the motors with core described above, it is preferable to establish the dimension in the radial direction from each of the magnetic flux converging surfaces of the teeth sections to the corresponding base merging section of each of the teeth sections where the teeth section meets the corresponding core rib section to be generally (L1−L2)/2 away from the corresponding magnetic flux converging surface, in other words, to be generally equal to the width of one half side of the teeth section, since this secures coil space and makes winding the coil easy, in addition to preventing magnetic saturation from occurring, as described above.

Moreover, in the motor with core described above, the manufacture of the cores can be simplified by forming a rear wall surface of each of the teeth sections on the opposite side of the magnetic flux converging surface to be generally flat.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a front view of a structure of a six-pole rotor core in accordance with an embodiment of the present invention.

FIG. 2 shows a front view of an assembled state of a rotor using the rotor core shown in FIG. 1.

FIG. 3 shows a front view of an assembled state of a stator core in accordance with another embodiment of the present invention.

FIG. 4 is a graph showing the relationship between the shape of teeth and the cogging level.

FIG. 5 is a graph showing cogging waveforms with and without dummy slots.

FIG. 6 shows a front view of an assembled state of a stator core in accordance with still another embodiment of the present invention.

FIG. 7 shows a front view of an assembled state of a stator core in accordance with yet another embodiment of the present invention.

FIG. 8 shows a front view of an assembled state of a stator core in accordance with a further embodiment of the present invention.

FIG. 9 shows a horizontal cross-sectional view of an example of a structure of a common motor with core.

FIG. 10 shows a vertical cross-sectional view of the motor with core shown in FIG. 9.

FIG. 11 shows a front view of a structure of a rotor core used in the motor with core shown in FIG. 9.

FIG. 12 shows a horizontal cross-sectional view of an example of a structure of a motor with core.

### DETAILED DESCRIPTION OF PREFERRED EMBODIMENTS

Embodiments of the present invention are described in detail below with reference to the accompanying drawings.

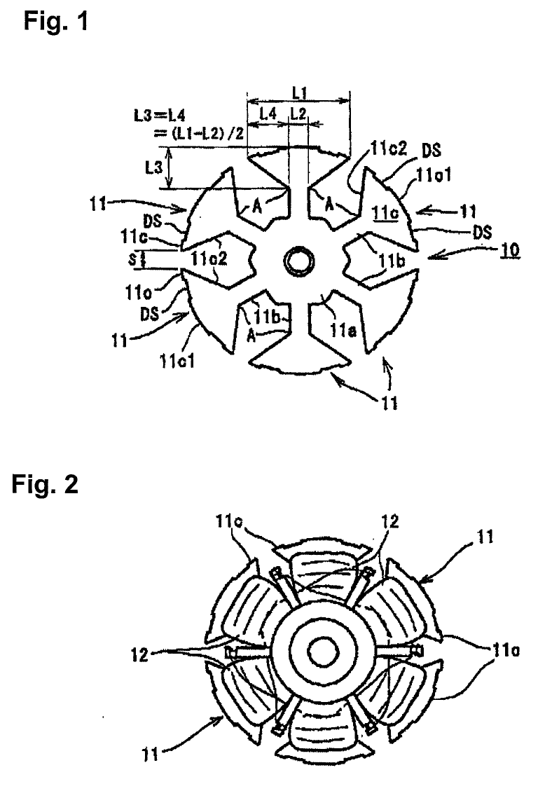

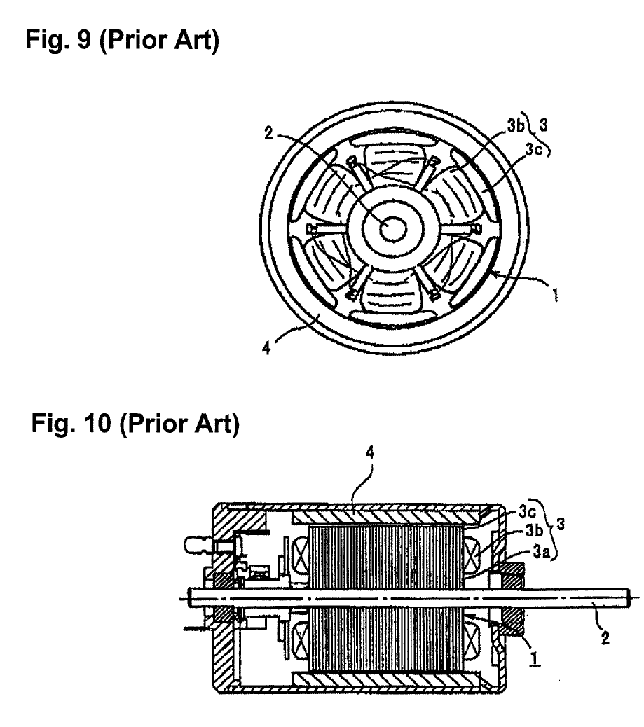

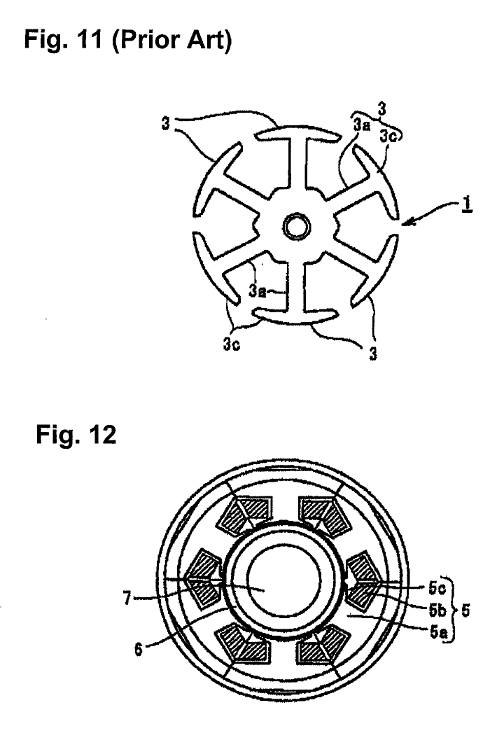

First, the embodiment shown in FIGS. 1 and 2 shows a six-pole rotor core 10 used in a motor with brush in accordance with an embodiment of the present invention (see FIGS. 9 and 10 for the overall structure of the motor), where the rotor core 10 has six salient poles 11 in the circumferential direction. Each of the salient poles 11 has a core rib section 11b, which radially, outwardly extends in the radial direction from a ring-shaped center base section 11a, and a coil winding 12 is wound around each of the core rib sections 11b.

At the end part on the outer side in the radial direction of each of the core rib sections 11b that constitutes each of the salient poles 11 is a teeth section 11c that expands and extends in a generally triangular shape, or a fan shape, from the corresponding core rib section 11b towards either side in the generally circumferential direction. Each of the teeth sections 11c has a magnetic flux converging surface 11c1 on the end surface on the outer side in the direction the core rib section 11b extends (radial direction), and each of the magnetic flux converging surfaces 11c1 is arranged to be in close proximity in the radial direction to a cylindrical stator magnet (not shown) that generally encircles the rotor core 10.

A rear wall surface 11c2 extends on the other end in the radial direction of each of the magnetic flux converging surfaces 11c1 of each teeth section 11c. Each of the rear wall surfaces 11c2 is formed by a flat surface that extends in a generally straight line to connect either end in the circumferential direction of each magnetic flux converging surface 11c1 with a corresponding side wall surface in the circumferential direction of the corresponding core rib section 11b. Each of the flat rear wall surfaces 11c2 is formed on a slope that extends at a predetermined angle to the radial direction, so that the rear wall surface 11c2 intersects with the corresponding side wall surface in the circumferential direction of the corresponding core rib section 11b at a base merging section A.

When the width dimension tangent to each of the magnetic flux converging surfaces 11c1 in the circumferential direction of each teeth section 11c is L1 and the width dimension of each of the core rib sections 11b in the direction orthogonal to the direction the core rib section 11b extends (radial direction) is L2, the position of the base merging section A in each of the teeth sections 11c where the teeth section 11c meets the corresponding core rib section 11b is established as follows: the position of the base merging section A in the radial direction is set at a distance of (L1−L2)/2 or more away from the corresponding magnetic flux converging surface 11c1, which is the outer most circumferential surface of the corresponding teeth section 11c, and towards the center in the radial direction. In the present embodiment, this position is determined by a dimension equivalent to (L1−L2)/2.

More specifically, when a dimension measured from a magnetic flux inflow/outflow surface of each of the teeth sections 11c to a position where the teeth section 11c meets the corresponding core rib section 11b, in other words, a dimension from each of the magnetic flux converging surfaces 11c1 of each teeth section 11c to the corresponding base merging section A where the teeth section 11c meets the corresponding core rib section 11b is L3, and the width dimension of one half side of each of the teeth sections 1c is L4 , the dimension L3 may be equivalent to the width dimension L4 (i.e., L3:L4 =1:1), or greater than L4 (L3≧L4). As a result, there is hardly any magnetic saturation on any of the magnetic flux inflow/outflow surfaces in any of the base merging sections A where each of the teeth sections 11c meets the corresponding core rib section 11b; and this reduces such performance characteristic as cogging, torque ripple and back electromotive voltage distortion and improved the rotation performance.

In the meantime, a slot width S between two adjacent teeth sections 11c of the salient poles 11 is set to be smaller than the width dimension L4 (L4=(L1−L2)/2) of one half side of each of the teeth sections 1c (S<L4).

Further in the present embodiment, dummy slots DS are provided on each of the magnetic flux converging surfaces 11c1 of each teeth section 11c as a countermeasure against cogging. The dummy slots DS are concavely formed, so that parts of the magnetic flux converging surface 11c1 are depressed. In the present embodiment, there are two dummy slots DS formed on each teeth section 11c, and the dummy slots DS at two locations are formed symmetrically with respect to the center in the circumferential direction of each teeth section 11c.

It is preferable that the number of dummy slots DS provided per core pole is an integer value equal to or less than one-third of the number of core poles (e.g., six poles according to the present embodiment), and it is desirable that the width dimension in the circumferential direction of each of the dummy slots DS is smaller than the slot width S between adjacent poles. Further, the depth of each of the dummy slots DS may preferably be in the range of about 0.01 mm-0.8 mm; each of the dummy slots DS according to the present invention is 2 mm in width and 0.25 mm in depth.

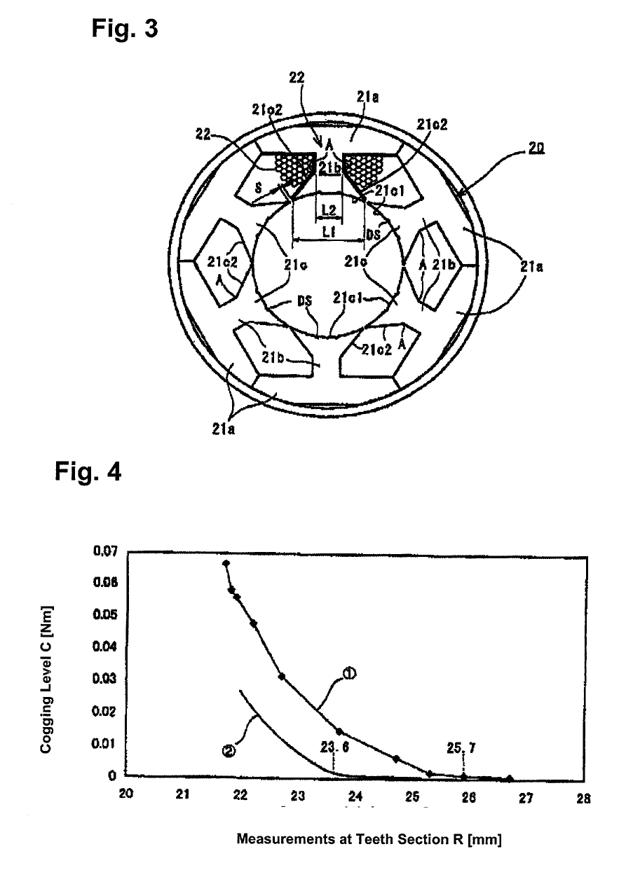

FIG. 3 shows an example in accordance with one embodiment of the present invention in which a six-pole stator core 20 is used in an inner rotor-type brushless motor. The stator core 20 has six salient poles 21 dispersed and arranged in the circumferential direction. Each of the salient poles 21 has a core rib section 21b that radially extends towards the center in the radial direction from an outer base section 21a, and a coil winding 22 is wound around each of the core rib sections 21b.

At the end part towards the center in the radial direction of each of the core rib sections 21b that constitutes each of the salient poles 21 is a teeth section 21c that expands and extends in a nearly fan shape towards either side in the generally circumferential direction, with the corresponding core rib section 21b as the center. Each of the teeth sections 21c has a magnetic flux converging surface 21c1 on the end surface on the inner side in the direction in which the core rib section 21b extends (radial direction), and each of the magnetic flux converging surfaces 21c1 is arranged to be in close proximity in the radial direction to a rotor magnet (not shown) placed in the center.

A rear wall surface 21c2 at the opposite end from each of the magnetic flux converging surfaces 21c1 of each teeth section 21c is formed by a flat surface that extends in a generally straight line from either end in the circumferential direction of the magnetic flux converging surface 21c1 towards a point on a corresponding side wall surface in the circumferential direction of the corresponding core rib section 21b. Each of the flat rear wall surfaces 21c2 extends diagonally at an appropriate angle to the radial direction, so that the rear wall surface 21c2 intersects with the corresponding side wall surface of the corresponding core rib section 21b in the circumferential direction at a base merging section A.

When the width dimension tangent in the circumferential direction to each of the magnetic flux converging surfaces 21c1 of each teeth section 21c is L1, while the width dimension of each of the core rib sections 21b in the direction orthogonal to the direction the core rib section 21b extends (radial direction) is L2, the position in the radial direction of the corresponding base merging section A, where the teeth section 21c meets with the corresponding core rib section 21b, is set to be (L1−L2)/2 or more away from the corresponding magnetic flux converging surface 21c1, which is the inner most circumferential surface of the corresponding teeth section 21c, and towards outside in the radial direction.

In other words, the dimension measured in the radial direction from a magnetic flux inflow/outflow surface of each of the teeth sections 21c to a section where the teeth section 21c meets the corresponding core rib section 21b, i.e., the dimension in the radial direction from each of the magnetic flux converging surfaces 21c1 of each teeth section 21c to the corresponding base merging section A where the teeth section 21c meets the corresponding core rib section 21b, may be equivalent (1:1) to or greater than the width dimension of one half side of the teeth section 21c. As a result of this, there is hardly any magnetic saturation in any of the base merging sections A, where each of the teeth sections 21c meets with the corresponding core rib section 21b; and this improves such performance characteristics as cogging, torque ripple and back electromotive voltage distortion.

For example, as shown in FIG. 4, when a dimension R (horizontal axis: in mm) in the radial direction from the center of the rotor core 20 to each of the base merging sections A is varied, the cogging level value C (vertical axis; in Nm) that corresponds to the R value changes as indicated by line \mathring{1}. Line \mathring{1} indicates changes when dummy slots DS, which are described later, are not used.

In the embodiment shown in FIG. 3, the dimension in the radial direction from the center of the rotor core 20 to each of the magnetic flux converging surfaces 21c1 of each teeth section 21c is set at 21.5 mm, the dimension {(L1−L2)/2} in the radial direction from each of the magnetic flux converging surfaces 21c1 to the corresponding base merging section A is set at 4.2 mm, and the dimension R in the radial direction from the center of the rotor core 20 to each of the base merging sections A is set at 25.7 mm. We can see from FIG. 4 that in the vicinity of R=25.7 mm, the cogging level value C is virtually zero, which means that there is hardly any cogging. Positions in the vicinity of R=25.7 mm are positions in which the dimension in the radial direction from each of the magnetic flux converging surfaces 21c1 of each teeth section 21c to the corresponding base merging section A where the teeth section 21c meets the corresponding core rib section 21b is nearly equivalent (1:1) to the width dimension of one half side of the teeth section 21c.

Further in the embodiment shown in FIG. 3, a slot width S between two adjacent teeth sections 21c of the salient poles 21 is set to be smaller than the width dimension (L1−L2)/2 of one half side of each of the teeth sections 21c, while at the same time dummy slots DS are provided as a cogging countermeasure on each of the magnetic flux converging surfaces 21c1 of each teeth section 21c in such a way that each of the dummy slots DS depresses a part of the magnetic flux converging surface 21c1, and there are two dummy slots DS formed on each teeth section 21c. The dummy slots DS in two locations are formed symmetrically with respect to the center in the circumferential direction of each teeth section 21c.

The cogging level is improved further as indicated by line \mathring{2} in FIG. 4, for example, when dummy slots DS as described above are provided. In other words, when dummy slots DS are provided, the cogging level can be improved favorably by having the position in the radial direction of each of the base merging sections A, where each teeth section 21c meets the corresponding core rib section 21b, set approximately (L1−L2)/4 or more away in the radial direction outwardly from the corresponding magnetic flux converging surface 21c1, which is the inner most surface of the teeth section 21c. As a result, the effect of the dummy slots DS is more smoothly exerted, and the cogging level is favorably improved.

In other words, for example, when the dimension in the radial direction from the center of the rotor core 20 to each of the magnetic flux converging surfaces 21c1 of each teeth section 21c is set at 21.5 mm, while the dimension {(L1−L2)/4} in the radial direction from each of the magnetic flux converging surfaces 21c1 to the corresponding base merging section A where the teeth section 21c meets the corresponding core rib section 21b is set at 2.1 mm, the dimension R in the radial direction from the center of the rotor core 20 to the base merging section A is 23.6 mm; and the value of the cogging level in the vicinity of R=23.6 mm is already improved and reduced to a low level.

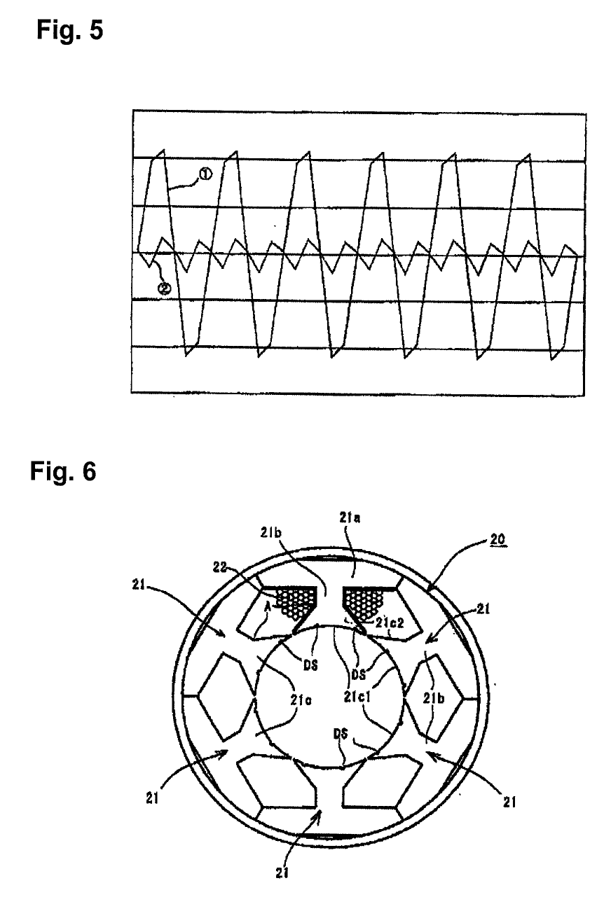

Furthermore, as shown in FIG. 5, the cycle of the cogging waveform that occurs with dummy slots (line \mathring{2}) is approximately one-half of the cycle of the cogging waveform that occurs without dummy slots (line \mathring{1}), and the absolute value of the cogging level with dummy slots is also significantly lower than that without dummy slots.

FIG. 6 shows another example in accordance with an embodiment of the present invention in which the positions of the dummy slots DS have been changed from their positions in the embodiment shown in FIG. 3, so that the two dummy slots DS formed at two locations on each teeth section 21c are asymmetrical with respect to the center in the circumferential direction of each teeth section 21c. By changing the positions or size of the dummy slots, the cycle and/or size of cogging waveforms can be altered appropriately within a certain range, and this allows optimum designing in terms of the motor's revolutions, rotating direction and/or rotation load.

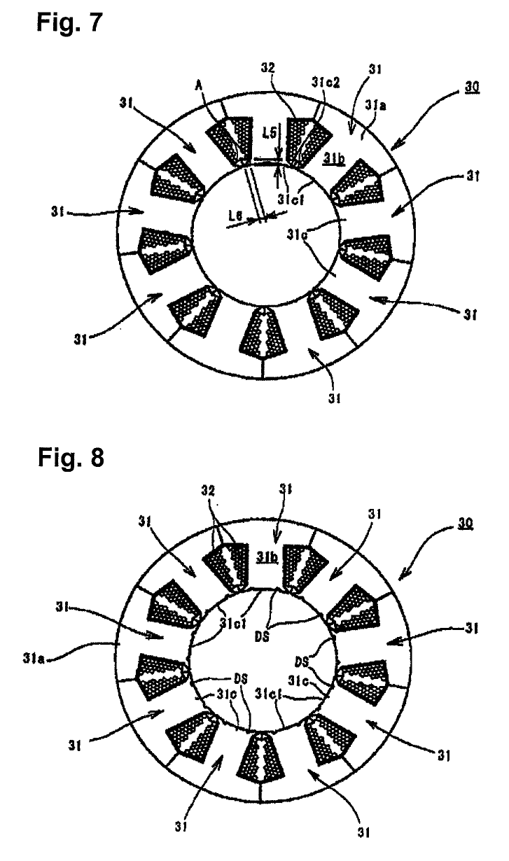

FIG. 7 shows still another embodiment of the present invention in which a nine-pole stator core 30 is used in an inner rotor-type brushless motor, in which the dimension from a magnetic flux inflow/outflow surface of each teeth section 31c of each salient pole 31 to a point where the teeth section 31c meets a corresponding core rib section 31b, i.e., a dimension L5 in the radial direction from each magnetic flux converging surface 31c1 of each teeth section 31c to a corresponding base merging section A where the teeth section 31c meets the corresponding core rib section 31b, is equivalent (1:1) to or larger than a width dimension L6 of one half side of the teeth section 31c.

Furthermore, FIG. 8 shows another embodiment of the present invention in which two dummy slots DS are formed at two locations on each pole in the embodiment shown in FIG. 7. Similar actions and effects as described earlier can be obtained in such an embodiment as well.

As described above, in a motor with core according to the present invention, a base merging section of each teeth section where the teeth section meets a corresponding core rib section is at a position removed from a corresponding magnetic flux converging surface of the teeth section by a distance equal to or greater than a predetermined amount of distance in the radial direction; and the dimension measured from a magnetic flux inflow/outflow surface of the teeth section to a point where the teeth section meets the corresponding core rib section, i.e., the dimension from the magnetic flux converging surface of the teeth section to the base merging section where the teeth section meets the corresponding core rib section, is equivalent to or larger than the width dimension of one half side of the magnetic flux converging surface. As a result, there is hardly any magnetic saturation on the magnetic flux inflow/outflow surface at the base merging section where the teeth section meets the corresponding core rib section, and this improves such performance characteristics as cogging, torque ripple and back electromotive voltage distortion. Consequently, a motor with core that has favorable rotation performance can be obtained at low costs.

Further, by setting the base merging section of each of the teeth sections where the teeth section meets the corresponding core rib section at a position removed from the magnetic flux converging surface of the teeth section by a distance equal to or greater than a predetermined amount of distance in the radial direction, and by setting the dimension of the magnetic flux inflow/outflow surface of the teeth section until the teeth section meets the corresponding core rib section, i.e., the dimension from the magnetic flux converging surface of the teeth section to the corresponding base merging section where the teeth section meets the corresponding core rib section, to be enough or more than enough to allow the effect of dummy slots to materialize, magnetic saturation on the magnetic flux inflow/outflow surface at the base merging section where the teeth section meets the corresponding core rib section becomes restricted enough not to impede the effect of the dummy slots, which enhances the rotation performances; consequently, a motor with core that has favorable rotation performance can be obtained at low costs through a simple structure.

Moreover, since a rear wall surface of each of the teeth sections on the opposite side of the magnetic flux converging surface is formed to be generally flat in order to simplify the manufacture of cores, the effects described above can be further enhanced.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor with core comprising a core having a plurality of salient poles, each of the salient poles having a teeth section defining a magnetic flux converging surface having a width L1 in a circumferential direction and a base section opposing to the magnetic flux converging surface, and a core rib section connecting to the teeth section at the base section of the teeth section, the core rib section having a width L2 in a direction orthogonal to a direction in which the core rib section extends radially, wherein the base section is set at a location that is about (L1−L2)/2 or greater away in the radial direction from the magnetic flux converging surface of the teeth section.

2. A motor with core according to claim 1, wherein the base section is set at a location that is about (L1−L2)/2 away in the radial direction from the magnetic flux converging surface of the teeth section.

3. A motor with core according to claim 2, wherein the magnetic flux converging surface of the teeth section is composed of an arcuate surface that does not have any dummy slot for cogging torque adjustment.

4. A motor with core according to claim 1, wherein the teeth section has a generally flat rear wall surface on the opposite side of the magnetic flux converging surface.

5. A motor with core according to claim 1, wherein the teeth section is generally in a fan shape having an arcuate surface defining the magnetic flux converging surface, a narrower base merging section connecting to the core rib section, and generally flat rear surfaces extending at an angle with respect to the core rib section and connecting the arcuate surface and the narrower base merging section.

6. A motor with core according to claim 1, wherein the core rib section has side wall surfaces extending in a radial direction and the teeth section has generally flat rear wall surfaces on the opposite side of the magnetic flux converging surface, the rear wall surfaces intersecting at an angle with the respective side wall surfaces of the core rib section.

7. A motor with core comprising a core having a plurality of salient poles, each of the salient poles having a teeth section defining a magnetic flux converging surface having dummy slots for cogging torque adjustment and having a width L1 in a circumferential direction and a base merging section opposing to the magnetic flux converging surface, and a core rib section connecting to the teeth section at the base merging section of the teeth section, the core rib section having a width L2 in a direction orthogonal to a direction in which the core rib section extends radially, wherein the base merging section is set at a location that is about (L1−L2)/4 or greater away in the radial direction from the magnetic flux converging surface of the teeth section.

8. A motor with core according to claim 7, wherein the base merging section is set at a location that is about (L1−L2)/4 away in the radial direction from the magnetic flux converging surface of the teeth section.

9. A motor with core according to claim 7, wherein the teeth section has a generally flat rear wall surface on the opposite side of the magnetic flux converging surface.

10. A core for a motor, the core comprising at least one salient pole having a teeth section defining a magnetic flux converging surface having a width L1 in a circumferential direction and a base section opposing to the magnetic flux converging surface, and a core rib section connecting to the teeth section at the base section of the teeth section, the core rib section having a width L2 in a direction orthogonal to a direction in which the core rib section extends radially, wherein the base section is set at a location that is about (L1−L2)/2 or greater away in the radial direction from the magnetic flux converging surface of the teeth section.

11. A core according to claim 10, wherein the base section is set at a location that is about (L1−L2)/2 away in the radial direction from the magnetic flux converging surface of the teeth section.

12. A core according to claim 10, wherein the magnetic flux converging surface of the teeth section is composed of an arcuate surface that does not have any dummy slot for cogging torque adjustment.

13. A core according to claim 10, wherein the teeth section has a generally flat rear wall surface on the opposite side of the magnetic flux converging surface.

14. A core according to claim 10, wherein the teeth section is generally in a triangular shape having an arcuate surface defining the magnetic flux converging surface, a narrower base merging section connecting to the core rib section, and generally flat rear surfaces extending at an angle with respect to the core rib section and connecting the arcuate surface and the narrower base merging section.

15. A core according to claim 10, wherein the core rib section has side wall surfaces extending in a radial direction and the teeth section has generally flat rear wall surfaces on the opposite side of the magnetic flux converging surface, the rear wall surfaces intersecting at an angle with the respective side wall surfaces of the core rib section.

16. A core for a motor, the core comprising at least one salient pole having a teeth section defining a magnetic flux converging surface having dummy slots for cogging torque adjustment and having a width L1 in a circumferential direction and a base merging section opposing to the magnetic flux converging surface, and a core rib section connecting to the teeth section at the base merging section of the teeth section, the core rib section having a width L2 in a direction orthogonal to a direction in which the core rib section extends radially, wherein the base merging section is set at a location that is about (L1−L2)/4 or greater away in the radial direction from the magnetic flux converging surface of the teeth section.

17. A core according to claim 16, wherein the base merging section is set at a location that is about (L1−L2)/4 away in the radial direction from the magnetic flux converging surface of the teeth section.

18. A core according to claim 16, wherein the teeth section has a generally flat rear wall surface on the opposite side of the magnetic flux converging surface.

19. A core according to claim 16, wherein the teeth section is generally in a triangular shape having an arcuate surface defining the magnetic flux converging surface, a narrower base merging section connecting to the core rib section, and generally flat rear surfaces extending at an angle with respect to the core rib section and connecting the arcuate surface and the narrower base merging section.

20. A core according to claim 16, wherein the core rib section has side wall surfaces extending in a radial direction and the teeth section has generally flat rear wall surfaces on the opposite side of the magnetic flux converging surface, the rear wall surfaces intersecting at an angle with the respective side wall surfaces of the core rib section.
